(19) United States
(12) Patent Application Publication
(10) Pub. No.: US 2013/0135092 A1
(43) Pub. Date: May 30, 2013

(54) DRIVING BEHAVIOR ANALYSIS AND WARNING SYSTEM AND METHOD THEREOF

(71) Applicants: Bing-Fei Wu, Hsinchu (TW); Chao-Jung Chen, Hsinchu County (TW); Ying-Han Chen, Tainan (TW); Chung-Hsuan Yeh, Changhua County (TW)

(72) Inventors: Bing-Fei Wu, Hsinchu (TW); Chao-Jung Chen, Hsinchu County (TW); Ying-Han Chen, Tainan (TW); Chung-Hsuan Yeh, Changhua County (TW)

(73) Assignee: NATIONAL CHIAO TUNG UNIVERSITY, Hsinchu (TW)

(21) Appl. No.: 13/423,501

(22) Filed: Mar. 19, 2012

(30) Foreign Application Priority Data
Nov. 25, 2011 (TW) 100143301

(51) Int. Cl. B60Q 1/00

(52) U.S. Cl. 340/439

(57) ABSTRACT

A driving behavior analysis and warning system is adapted to detect the driving behavior of a driver driving an automobile and to provide a warning signal corresponding to the driving behavior. The analysis and warning system receives drive information captured by an external and/or an internal drive system via an information collection unit, and analysis module integrated with a algorithm is then used to analyze the drive information to produce drive safety signals, enabling the driver to determine whether driver driving behavior is normal or not through an output unit, so as to prevent injury caused by dangerous driving. Moreover, this invention also provides a method for analyzing and warning driving behavior.

### CROSS-REFERENCE TO RELATED APPLICATION

This non-provisional application claims priority under 35 U.S.C. §119(a) on Patent Application No(s). 100143301 filed in Taiwan, R.O.C. on Nov. 25, 2011, the entire contents of which are hereby incorporated by reference.

### FIELD OF THE INVENTION

The present invention relates to a driving behavior analysis and warning system and method thereof, and more particularly to a driving behavior analysis and warning system and method thereof in which driving data about conditions outside and/or inside a car being steered are collected for generating a corresponding driving safety signal as a warning, based on which a driver may timely judge whether his or her driving behavior is in a normal or an abnormal driving state.

### BACKGROUND OF THE INVENTION

Many countries have conducted big-scaled researches and developments about intelligent transportation systems. Among others, the issue of ensuring driving safety through analysis of drivers' driving behaviors has received particularly wide attention. Since it is clear the driving safety has direct relation with the driver's normal and abnormal driving behaviors, many systems for detecting driver's driving behavior have been developed and introduced into the market. These systems usually include the detection of a driver's physiological signals, such as the movement of the driver's head, the changes in the driver's heartbeat, the moving track of the steering wheel, the driver's eye movement and the like.

According to related literatures, conventional driving behavior analysis methods can be classified into two major types according to the sources of signals being analyzed. A first type is the physiological signal analysis method that utilizes a driver's physiological signals and other physiological conditions derived therefrom to analyze the driver's driving behavioral state; and the other type is the driving performance analysis method that uses a driver's driving performance as a signal to analyze the driver's driving behavior.

According to the physiological signal analysis method, a driver's behavioral state is directly reflected in the driver's physiological signals. For example, when a driver is half asleep or in a drowsy driving state, there would be changes in the driver's electroencephalogram (EEG). And, when a driver is distracted during driving, the driver would usually shift eyes from the road ahead to another direction or object, such as a navigator mounted on the car. This distracted state can be recognized by further analyzing the driver's line of sight with an image recognition technique. However, it is actually very difficult to realize the aforesaid recognition technique in driver's driving behavior analysis. For example, the driver would not be willing to wear an electroencephalography during driving. And, according to related literatures, the recognition technique for recognizing and tracking human face, human eyes, facial expression, and lip movements is largely adversely affected when the human face is in an environment with complicated changes of light and shadow, such as driving in daytime. The robustness of the algorithm used in the analysis also has important influence on the effect of the recognition technique. Moreover, the analysis based on the recognition of the driver's line of sight is completely useless when the driver wears a pair of sunglasses. While the physiological signal analysis method has the advantage of high accuracy in measurement, it can not be easily effectuated in the real life.

As to the driving performance analysis method, it analyzes the driving state according to the driving behavior occurred as a result of the driver's state. In other words, the driver's driving state is indirectly judged. For example, the drowsy driving usually is reflected in a driving performance with increased reaction time and slowed control of steering wheel. The disadvantage of the driving performance analysis method is that it is almost limited to qualitative description of the driver's driving behaviors without quantitative analysis, so that it is uneasy for the driver to judge his or her driving behavior according to the analysis result.

It is therefore necessary to develop an improved driving behavior analysis and warning system and method to overcome the drawbacks in the prior art analysis systems and methods.

### SUMMARY OF THE INVENTION

A primary object of the present invention is to provide a driving behavior analysis and warning system for detecting and analyzing a driver's driving behavior during driving a car and generating a corresponding driving safety signal for timely warning the driver of an abnormal driving behavior.

Another object of the present invention is to provide a driving behavior analysis and warning method for detecting and analyzing a driver's driving behavior during driving a car and generating a corresponding driving safety signal as a warning, so that the driver may timely judge his or her driving behavior based on the driving safety signal.

To achieve the above and other objects, the driving behavior analysis and warning system according to the present invention is used to detect a driver's driving behavior during driving a car, and includes a data collection unit, an analysis module, and an output unit. The data collection unit is installed on the car for collecting driving data about conditions outside and/or inside the car. The analysis module is electrically connected to the data collection unit for generating a driving safety signal according to the collected driving data, and the driving safety signal has connection with the driver's driving behavior. The output unit is electrically connected to the analysis module for outputting the driving safety signal, according to which the driver may timely judge his or her driving behavior.

To achieve the above and other objects, the driving behavior analysis and warning method according to the present invention is used to detect a driver's driving behavior during driving a car and to generate warning signal corresponding to the driver's driving behavior, and includes the steps of (a) collecting driving data about conditions outside and/or inside the car; (b) analyzing the driving data to generate a driving safety signal corresponding to the driver's driving behavior; and (c) outputting the driving safety signal for the driver to timely judge his or her driving behavior according to the driving safety signal.

Compared to the prior art, the driving behavior analysis and warning system and method of the present invention collects not only driving data about conditions outside the car supplied by, for example, a Lane Departure Warning System (LDWS), a Forward Collision Warning System (FCW), an accelerometer or a G-sensor, and/or other driving recorder systems mounted on the car, but also driving data about conditions inside the car, such as accelerator pedal stepping data, driving speed data, brake pedal stepping data, fuel consumption data, data about turns made by the driver, and data indicating the use of the directional and other lights on the car by the driver. These driving data are analyzed by an analysis module to obtain data about the lane width, the distance between one lateral side of the car and an adjacent lane line, the number of times the car is moved into the right lane, the variation in the lateral velocity of the car, the extent by which the car is moved across an adjacent lane line, the distance between the car and a preceding car, the driver's reaction time for keeping a safe distance between the car and the preceding car, and the variation in the driving speed of the car. The above-mentioned driving data are then computed by a decision-making unit with an algorithm, such as a fuzzy algorithm, embedded in the analysis module to generate a driving safety signal, which is output for the driver to judge whether his or her driving behavior is in a normal driving state.

According to an embodiment of the present invention, the driving safety signal generated by the analysis module can be represented in a quantitative manner to indicate several different warning ranges, so that the driver is quickly, directly and clearly warned of his or her current driving state as safe driving, drowsy driving, distracted driving or drunk driving. In this way, hazards to the driver and other drivers caused by dangerous driving can be avoided.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of a driving behavior analysis and warning system according to a first embodiment of the present invention;

FIG. 2 illustrates a first type of driving data collected in the driving behavior analysis and warning system of FIG. 1;

FIG. 3 illustrates a second type of driving data collected in the driving behavior analysis and warning system of FIG. 1;

FIG. 4 illustrates a third type of driving data collected in the driving behavior analysis and warning system of FIG. 1;

FIG. 5 is a block diagram of a driving behavior analysis and warning system according to a second embodiment of the present invention; and

FIG. 6 is a flowchart showing the steps included in a driving behavior analysis and warning method according to an embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

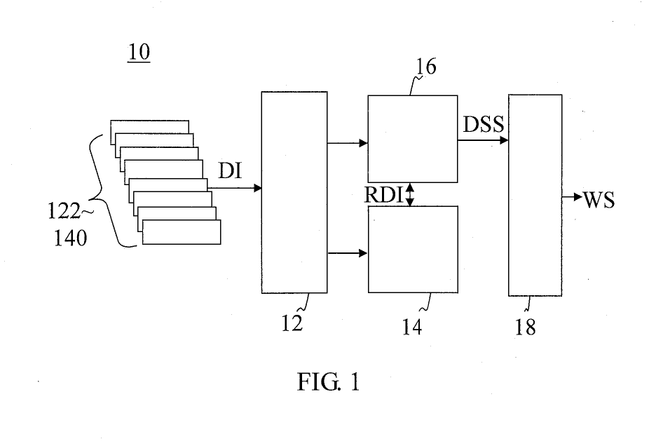

Please refer to FIG. 1 that is a block diagram of a driving behavior analysis and warning system 10 according to a first embodiment of the present invention. As shown, the driving behavior analysis and warning system 10 is used to detect a driver's driving behavior during driving a car and to generate a warning signal WS corresponding to the detected driving behavior. The driver's driving behavior may be, for example, safe driving, drowsy driving, distracted driving, or drunk driving. Herein, the drowsy driving, the distracted driving and the drunk driving are defined as abnormal driving or dangerous driving; and the safe driving is defined as normal driving. However, while the above-mentioned normal driving and abnormal driving are defined according to some examples of the drivers' driving behavioral states, it is understood the expression of “driving behavior” used herein means a driver's all behaviors in connection with driving.

As shown in FIG. 1, the driving behavior analysis and warning system 10 in the first embodiment includes a data collection unit 12, a memory unit 14, an analysis module 16, and an output unit 18. The data collection unit 12 is installed on a car for collecting relevant driving data DI about conditions outside and/or inside the car. The driving data DI about conditions outside the car may be, for example, a lane departure data 122 provided by a Lane Departure Warning System (LDWS), a preceding-car detection data 124 provided by a Forward Collision Warning (FCW) System, a gravity sensing data 126 provided by an accelerometer or a G-sensor, or other driving-related data 128 provided by other sensing systems mounted on the car. Further, the driving data DI about conditions inside the car may be, for example, an accelerator-pedal stepping data 130, a driving speed data 132, a brake-pedal stepping data 134, a fuel consumption data 136, a data about the turns made by the driver 138, and a data about the use of directional or other lights on the car by the driver 140. The above-mentioned driving data DI are now discussed in more details below.

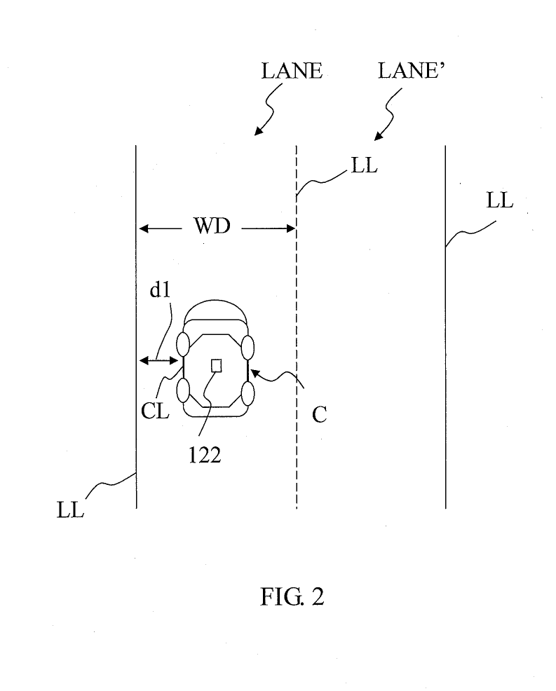

Please refer to FIG. 2 along with FIG. 1. The lane departure data 122 from the Lane Departure Warning System provides parameters of lanes LANE, LANE′ and lane lines LL in connection with a car C, on which the driving behavior analysis and warning system 10 is installed. Wherein, the lane lines LL are used to define the lanes LANE, LANE′. The lane departure data 122 provided by the Lane Departure Warning System may include, for example, the width WD of the lanes LANE, LINE′, a distance d1 between a lateral side CL of the car C and an adjacent lane line LL, the number of times the car C is moved into the right lane LANE′, the variation in a lateral velocity of the car C, and the extent by which the car C is moved across an adjacent lane line LL.

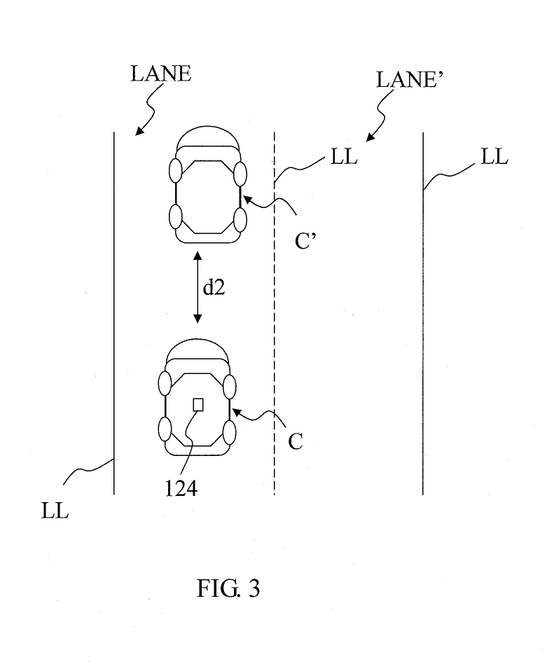

Please refer to FIG. 3 along with FIG. 1. The preceding-car detection data 124 provided by the Forward Collision Warning System includes, for example, a distance d2 between the car C and a preceding car C′. With the distance d2, it is possible to determine whether the driver's driving behavior is in a drowsy driving state. The drowsy driving has relation to the driver's reaction time, i.e. the time needed by the driver to make necessary action for keeping a safe distance between the car C and the preceding car C′. More specifically, the reaction time means the time taken by the driver to emergently step the brake pedal in response to a preceding car C′ that is too close to the car C. Thus, the data collection unit 12 of the present invention can obtain via the Forward Collision Warning System the driving data DI about the distance d2 between the car C and the preceding car C′ and the driver's reaction time for keeping a safe distance between the car C and the preceding car C′.

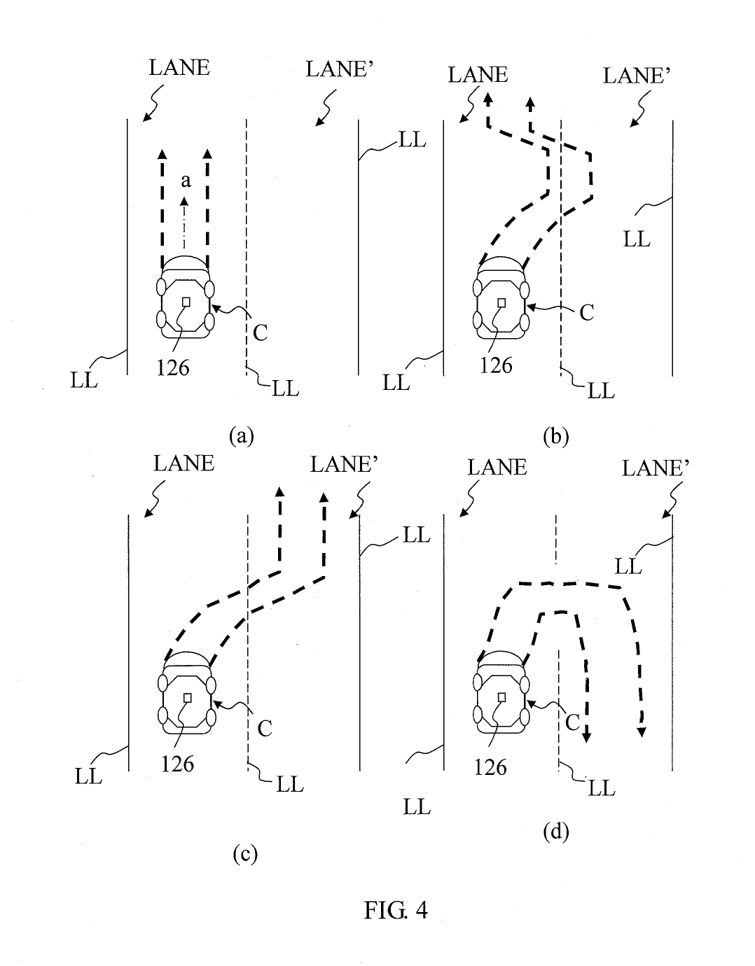

Please refer to FIG. 4 along with FIG. 1. The G-sensor serves to sense an accelerating state “a” of the car C and generates a gravity sensing signal, i.e. the gravity sensing data 126. Generally speaking, the gravity sensing signal 126 is generated corresponding to several different types of driving conditions, including moving straight forward as shown in FIG. 4(a), moving zigzag as shown in FIG. 4(b), making a turn normally as shown in FIG. 4(c), and making a turn abnormally as shown in FIG. 4(d). The gravity sensing signal 126 of the G-sensor is in a stable state when the driver steers the car C to move straight forward within its lane; oscillates to and fro in a symmetric manner when the driver steers the car C to zigzag in and out its lane; presents a stable change when the driver makes a turn in a normal way; and presents a drastic change when the driver makes a turn in an abnormal way. Thus, the data collection unit 12 of the present invention can obtain via the G-sensor the driving data DI about the variation in the driving speed of the car C, and determines, according to the obtained driving data DI about the variation in the driving speed, the driving condition of the car C as moving straight forward, moving zigzag, making a turn normally, or making a turn abnormally.

Please refer back to FIG. 1. The memory unit 14 is electrically connected to the data collection unit 12 for storing the driving data DI therein. The driving data DI, once stored in the memory unit 14, are defined as reference driving data RDI. In the present invention, the memory unit 14 is optional. For instance, when the driving behavior analysis and warning system 10 is designed for dynamic and real-time analysis, the memory unit 14 is a non-required optional item.

Generally speaking, an abnormal driving behavior is not an instantaneously occurred state, but a state that forms through a series of gradual, successive changes over a period of time. Therefore, in the illustrate first embodiment, the memory unit 14 is provided for storing driving data DI concerning the driver's last or even all previous driving behaviors for subsequent analyzing by the analysis module 16. Since the driving data DI stored in the memory unit 14 are about the driver's reference driving behaviors, it is particularly defined as reference driving data RDI.

The analysis module 16 is electrically connected to the data collection unit 12 for generating a driving safety signal DSS according to the driving data DI. That is, the driving safety signal DSS has connection with the driver's driving behavior.

In a variant of the first embodiment, the analysis module 16 is simultaneously connected to the data collection unit 12 and the memory unit 14 for generating the driving safety signal DSS after analyzing both of the driving data DI and the reference driving data RDI. That is, the generated driving safety signal DSS has connection with the driver's driving behaviors. Further, the analysis module 16 analyzes the driving data DI collected by the data collection unit 12 with an algorithm to derive the parameters of different contents of the driving data DI, so as to generate the driving safety signal DSS based on the driving data DI.

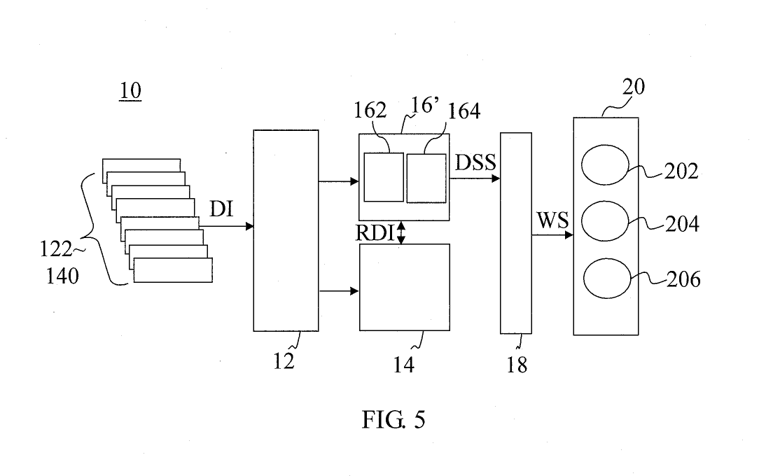

Please refer to FIG. 5 that is a block diagram of a second embodiment of the driving behavior analysis and warning system 10 of the present invention. The second embodiment is different from the first embodiment in an analysis module 16′ and a visual warning unit 20. As shown, the analysis module 16′ includes a data analysis unit 162 and a decision-making unit 164. The data analysis unit 162 serves to analyze both the driving data DI and the reference driving data RDI. In other words, with the data analysis unit 162, it is possible to analyze the driving data DI and the reference driving data RDI, including the width WD of the lane LANE, the distance d1 between one lateral side CL of the car C and the adjacent lane line LL, the number of times the car C is moved into the right lane LANE′, the variation in the lateral velocity of the car C, the extent by which the car C is moved across the adjacent lane line LL, the distance d2 between the car C and the preceding car C′, the driver's reaction time for keeping a safe distance between the car C and the preceding car C′, the variation in the driving speed of the car C, the data about the stepping of the accelerator pedal by the driver, the data about the driving speed, the data about the stepping of the brake pedal by the driver, the fuel consumption data, the data about turns made by the driver, and the data indicating the use of the directional and other lights of the car C by the driver. After the driving data DI and the reference driving data RDI are analyzed, the decision-making unit 164 generates the driving safety signal DSS with an algorithm embedded in the analysis module 16. Wherein, the algorithm can be, for example, a fuzzy algorithm.

Further, the driving safety signal DSS may be generated corresponding to different driving behaviors, including but not limited to safe driving, drowsy driving, distracted driving, drunk driving and so on. Herein, the driving safety signal DSS is explained based on safe driving, drowsy driving, distracted driving, and drunk driving.

Further, the decision-making unit 164 can represent the driving safety signal DSS in a quantitative manner or a non-quantitative manner to indicate several different warning ranges WA, and the output unit 18 outputs a warning signal WS corresponding to a specific warning range WA indicated by the driving safety signal DSS. In the illustrated second embodiment, the driving safety signal DSS is represented in a quantitative manner to indicate, for example, three different warning ranges WA. That is, the quantitative driving safety signal DSS having a value lower than 80% indicates a warning range WA corresponding to abnormal driving; the quantitative driving safety signal DSS having a value ranged between 50% and 80% indicates a warning range WA corresponding to warning driving; and the quantitative driving safety signal DSS having a value lower than 50% indicates a warning range WA corresponding to dangerous driving. The visual warning unit 20 is electrically connected to the output unit 18 for showing warning signals corresponding to the above-mentioned warning ranges WA.

In the second embodiment, the visual warning unit 20 includes several lights, such as a green light 202, a yellow light 204, and a red light 206. For example, when the warning range WA corresponds to the abnormal driving, the green light 202 is continuously lighted, flashed, or intermittently lighted to warn the driver; when the warning range WA corresponds to the warning driving, the yellow light 204 can be continuously lighted, flashed, or intermittently lighted to warn the driver; and when the warning range WA corresponds to the dangerous driving, the red light 206 can be continuously lighted, flashed, or intermittently lighted to warn the driver. Therefore, the driver can be effectively warned via the lights.

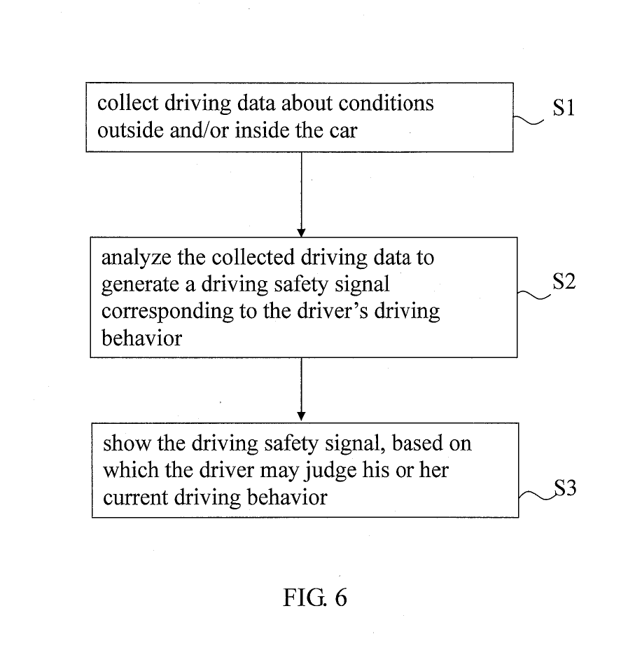

Please refer to FIG. 6 that is a flowchart showing the steps included in a driving behavior analysis and warning method according to an embodiment of the present invention. The method is used to analyze a driver's driving behavior during driving a car and to generate a warning signal corresponding to the driver's driving behavior. In a first step S1, driving data about conditions outside and/or inside the car are collected. The driving data are in connection with the driver's driving behavior and include, for example, the width WD of the lane being used, the distance between one lateral side of the car and the adjacent lane line, the number of times the car is moved into the right lane, the variation in the lateral velocity of the car, the extent by which the car is moved across the adjacent lane line, the distance between the car and a preceding car, the driver's reaction time for keeping a safe distance between the car and the preceding car, the variation in the driving speed of the car, the data about the stepping of the accelerator pedal by the driver, the data about the driving speed, the data about the stepping of the brake pedal by the driver, the fuel consumption data, the data about turns made by the driver, and the data indicating the use of the directional and other lights of the car by the driver. Wherein, each of the lanes is defined between two lane lines. Further, the detected variation in the driving speed can be used to determine the current condition of the car as moving straight forward, moving zigzag, making a turn normally, or making a turn abnormally.

In a second step S2, the driving data are analyzed to generate a driving safety signal corresponding to the driver's driving behavior, including but not limited to safe driving, drowsy driving, distracted driving, and drunk driving. In an operable embodiment, the driving data are analyzed with an algorithm to derive the driving safety signal, and the derived driving safety signal can be represented in a quantitative or non-quantitative manner for warning the driver. In another embodiment, different contents of the driving data may be differently weighted in the algorithm to derive the driving safety signal. For example, the driving behavior analysis and warning method may further includes the step of establishing a table of assigned weights, so as to assign a particular weight to each of the driving data. That is, in analyzing, the weight corresponding to each of the driving data can be located from the table of assigned weights for use.

Then, in a third step S3, a driving safety signal is shown for the driver to judge his or her current driving behavior or driving state. According to an embodiment of the present invention, the driving behavior analysis and warning method further includes the step of setting several different warning ranges, based on which the driving safety signal is classified to help the driver in judging his or her current driving behavior more easily. The warning ranges may correspond to, for example, abnormal driving and normal driving. The abnormal driving may include, for example, drunk driving, drowsy driving, and distracted driving. Moreover, the abnormal driving can be further classified into dangerous driving and warning driving according to the condition of drunk driving, drowsy driving, and distracted driving.

In an operable embodiment, the driving safety signal is represented in a quantitative manner, and it is possible to set that, for example, a quantitative driving safety signal having a value lower than 80% indicates a warning range corresponding to the abnormal driving; a quantitative driving safety signal having a value ranged between 50% and 80% indicates a warning range corresponding to the warning driving; and a quantitative driving safety signal having a value lower than 50% indicates a warning range corresponding to the dangerous driving. However, it is understood the number of warning ranges and the value ranges set for the quantitative driving safety signal can be increased or decreased, so as to design a warning manner most suitable for the driver.

In summary, the driving behavior analysis and warning system and method according to the present invention collects not only driving data about conditions outside the car supplied by, for example, a Lane Departure Warning System (LDWS), a Forward Collision Warning System (FCW), an accelerometer or a G-sensor, and/or other driving recorder systems, but also driving data about conditions inside the car, such as accelerator pedal stepping data, driving speed data, brake pedal stepping data, fuel consumption data, data about turns made by the driver, and data indicating the use of the directional and other lights of the car by the driver. These driving data are analyzed by an analysis module to obtain data about the lane width, the distance between one lateral side of the car and the adjacent lane line, the number of times the car is moved into the right lane, the variation in the lateral velocity of the car, the extent by which the car is moved across the adjacent lane line, the distance between the car and a preceding car, the driver's reaction time for keeping a safe distance between the car and the preceding car, and the variation in the driving speed of the car. The above-mentioned driving data are then computed by a decision-making unit with an algorithm, such as a fuzzy algorithm, embedded in the analysis module to generate a driving safety signal, which is output for the driver to judge whether he or she is driving normally.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A driving behavior analysis and warning system for detecting a driver's driving behavior during driving a car, comprising:
a data collection unit being installed on the car for collecting relevant driving data about conditions outside and/or inside the car;
an analysis module being electrically connected to the data collection unit for generating a driving safety signal according to the driving data collected by the data collection unit, and the driving safety signal having connection with the driver's driving behavior; and
an output unit being electrically connected to the analysis module for outputting the driving safety signal, with which the driver may judge his or her current driving behavior.

2. The driving behavior analysis and warning system as claimed in claim 1, further comprising a memory unit being electrically connected to the data collection unit for storing the collected driving data thereon; and the driving data stored on the memory unit forming reference driving data.

3. The driving behavior analysis and warning system as claimed in claim 1, wherein the driving data include at least one of a lane departure data, a preceding car detection data, a gravity sensing data, an accelerator pedal stepping data, a driving speed data, a brake pedal stepping data, a fuel consumption data, a data about turns made by the driver, and a data indicating the use of the directional and other lights of the car by the driver.

4. The driving behavior analysis and warning system as claimed in claim 3, wherein, from the lane departure data, the data collection unit collects at least one of the data about a lane width, a distance between a lateral side of the car and an adjacent lane line, the number of times the car is moved into a right lane, a variation in the car's lateral velocity, and an extent by which the car is moved across an adjacent lane line; and the lane being defined between two adjacent lane lines.

5. The driving behavior analysis and warning system as claimed in claim 3, wherein, from the preceding car detection data, the data collection unit collects at least one of the data about a distance between the driver's car and a preceding car and the driver's reaction time for keeping a safe distance between the car and a preceding car.

6. The driving behavior analysis and warning system as claimed in claim 3, wherein the data collection unit collects a variation in the car's driving speed from the gravity sensing data, and determines according to the variation in the driving speed whether the car is moving straight forward, moving zigzag, making turns normally, or making turns abnormally.

7. The driving behavior analysis and warning system as claimed in claim 2, wherein the analysis module includes a data analysis unit for analyzing currently collected driving data and the stored reference driving data.

8. The driving behavior analysis and warning system as claimed in claim 7, wherein the analysis module further includes a decision-making unit and an embedded algorithm, and the decision-making unit computing the currently collected driving data and the stored reference driving data with the algorithm to generate the driving safety signal.

9. The driving behavior analysis and warning system as claimed in claim 8, wherein the algorithm is a fuzzy algorithm.

10. The driving behavior analysis and warning system as claimed in claim 7, wherein the driving safety signal is represented in a quantitative manner via the decision-making unit for indicating several different warning ranges, so that the quantitative driving safety signal is output as a warning signal corresponding to one of the warning ranges.

11. The driving behavior analysis and warning system as claimed in claim 10, further comprising a visual warning unit being electrically connected to the output unit for showing the warning signals corresponding to the warning ranges.

12. The driving behavior analysis and warning system as claimed in claim 1, wherein the generated driving safety signal indicates the driver's driving behavior as one of safe driving, drowsy driving, distracted driving and drunk driving.

13. A driving behavior analysis and warning method for detecting a driver's driving behavior during driving a car and providing a warning signal corresponding to the detected driving behavior, comprising the following steps:
collecting driving data about conditions outside and/or inside the car;
analyzing the driving data to generate a driving safety signal corresponding to the driver's driving behavior; and
showing the driving safety signal for the driver to judge his or her current driving behavior or driving state.

14. The driving behavior analysis and warning method as claimed in claim 13, further comprising a step of storing the driving data to form reference driving data.

15. The driving behavior analysis and warning method as claimed in claim 14, wherein, in the step of analyzing the driving data, the reference driving data are compared with currently collected driving data.

16. The driving behavior analysis and warning method as claimed in claim 13, wherein the driving data collected in the step of collecting driving data include at least one of the data about a lane width, a distance between a lateral side of the car and an adjacent lane line, the number of times the car is moved into a right lane, a variation in the car's lateral velocity, and an extent by which the car is moved across an adjacent lane line; and the lane being defined between two adjacent lane lines.

17. The driving behavior analysis and warning method as claimed in claim 13, wherein the driving data collected in the step of collecting driving data include at least one of the data about a distance between the driver's car and a preceding car and the driver's reaction time for keeping a safe distance between the car and a preceding car.

18. The driving behavior analysis and warning method as claimed in claim 13, wherein the driving data collected in the step of collecting driving data include a variation in the car's driving speed, which is analyzed in the step of analyzing the driving data for determining whether the car is moving straight forward, moving zigzag, making turns normally, or making turns abnormally.

19. The driving behavior analysis and warning method as claimed in claim 13, wherein the driving data collected in the step of collecting driving data include at least one of an accelerator pedal stepping data, a driving speed data, a brake pedal stepping data, a fuel consumption data, a data about turns made by the driver, and a data indicating the use of the directional and other lights of the car by the driver.

20. The driving behavior analysis and warning method as claimed in claim 13, wherein the step of analyzing the driving data further includes a step of analyzing the driving data with an algorithm to derive the driving safety signal.

21. The driving behavior analysis and warning method as claimed in claim 20, wherein, in the algorithm, each of the driving data is differently weighted according to its content for generating the driving safety signal.

22. The driving behavior analysis and warning method as claimed in claim 21, further comprising a step of establishing a table of assigned weights, so as to assign a particular weight to each of the driving data according to the table of assigned weights.

23. The driving behavior analysis and warning method as claimed in claim 20, wherein the step of showing the driving safety signal further includes a step of setting several different warning ranges, based on which the driving safety signal is classified to help the driver in judging his or her driving behavior.

24. The driving behavior analysis and warning method as claimed in claim 23, wherein the warning ranges are corresponding to abnormal driving and normal driving.

25. The driving behavior analysis and warning method as claimed in claim 24, wherein the abnormal driving indicates the driver's driving behavior is any one of drunk driving, drowsy driving, and distracted driving.

26. The driving behavior analysis and warning method as claimed in claim 24, wherein the abnormal driving is further classified into dangerous driving and warning driving.

27. The driving behavior analysis and warning method as claimed in claim 24, wherein the step of showing the driving safety signal further includes a step of showing the driving safety signal in a quantitative manner to indicate different warning ranges; and the quantitative driving safety signal having a value lower than 80% indicating the warning range corresponding to the abnormal driving.

28. The driving behavior analysis and warning method as claimed in claim 26, wherein the quantitative driving safety signal having a value ranged between 50% and 80% indicates the warning range corresponding to the warning driving.

29. The driving behavior analysis and warning method as claimed in claim 26, wherein the quantitative driving safety signal having a value lower than 50% indicates the warning range corresponding to the dangerous driving.
